(19) United States
(12) Patent Application Publication
(10) Pub. No.: US 2023/0202545 A1
(43) Pub. Date: Jun. 29, 2023

(54) Powered Hand Truck Assembly

(71) Applicant: Flossie Jeffrey, Madison, AL (US)

(72) Inventor: Flossie Jeffrey, Madison, AL (US)

(21) Appl. No.: 17/561,169

(22) Filed: Dec. 23, 2021

(51) Int. Cl. B62B 5/00; B62B 3/04

(52) U.S. Cl. CPC B62B 5/0033; B62B 3/04

(57) ABSTRACT

A powered hand truck assembly for maneuvering loads in tight spaces includes a first housing, which is engaged to a frame. A handle is engaged to and extends upwardly from the frame. A lift module is engaged to and is electively extensible from the first housing. A load can be positioned on a tray, which is operationally engaged to the lift module. Tift module can selectively elevate the tray and the load. A pair of drive wheels, which are positioned singly on opposed facets of the first housing, is rotationally engaged to the first housing. A pair of drive motors is engaged to and positioned in the first housing. Each drive motor is operationally engaged to a respective drive wheel. The drive motors and the drive wheels can motivate the powered hand truck assembly and the load across a surface and can affect 360° turns.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to hand truck assemblies and more particularly pertains to a new hand truck assembly for maneuvering loads in tight spaces. The present invention discloses a hand truck assembly comprising a selectively elevatable the tray, wherein the tray comprises an endless belt, and two independently operable drive wheels allowing rotation about an axis for maneuvering the hand truck assembly in tight spaces

### (2) Description of Related Art Including Information Disclosed Under 37 CFR 1.97 and 1.98

The prior art relates to hand truck assemblies. Prior art hand truck assemblies may comprise hand truck assemblies wherein a tray is slidable relative to siderails of the hand truck assembly by means of electrically powered actuators. What is lacking in the prior art is a hand truck assembly wherein the tray in not engaged to the siderails, but still can be selectively elevated by an electrically powered actuator. Additionally lacking in the prior art is a hand truck assembly wherein the tray comprises an endless belt. Still further lacking in the prior art is a hand truck assembly comprising two independently operable drive wheels allowing rotation about an axis for maneuvering the hand truck assembly in tight spaces.

### BRIEF SUMMARY OF THE INVENTION

An embodiment of the disclosure meets the needs presented above by generally comprising a first housing, which is engaged to a frame and which defines an interior space. A handle is engaged to the frame and extends upwardly from proximate to a rear of the frame. A lift module is engaged to and is electively extensible from the first housing. A tray is operationally engaged to the lift module and extends from a front of the frame. The tray is configured for positioning of a load, while the lift module is configured to selectively elevate the tray and the load. A pair of drive wheels, which are positioned singly on opposed facets of the first housing, is rotationally engaged to the first housing. A pair of drive motors is engaged to the first housing and positioned in the interior space. Each drive motor is operationally engaged to a respective drive wheel. The drive motors and the drive wheels are configured to motivate the powered hand truck assembly and the load across a surface and to effect 360° turns about a midpoint of an axis of rotation of the drive wheels.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of a powered hand truck assembly according to an embodiment of the disclosure.

FIG. 2 is a rear view of an embodiment of the disclosure.

FIG. 3 is a front view of an embodiment of the disclosure.

FIG. 4 is a top view of an embodiment of the disclosure.

FIG. 5 is a rear cut-away view of an embodiment of the disclosure.

FIG. 6 is a front cut-away view of an embodiment of the disclosure.

FIG. 7 is an in-use view of an embodiment of the disclosure.

FIG. 8 is an in-use view of an embodiment of the disclosure.

FIG. 9 is an in-use view of an embodiment of the disclosure.

FIG. 10 is a detail view of an embodiment of the disclosure.

### DETAILED DESCRIPTION OF THE INVENTION

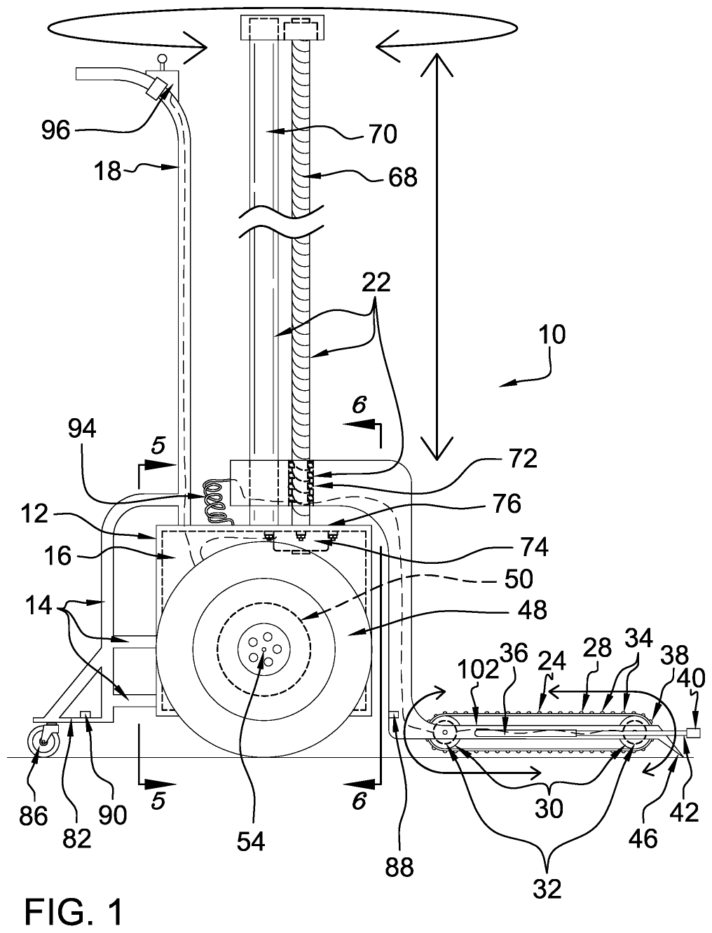

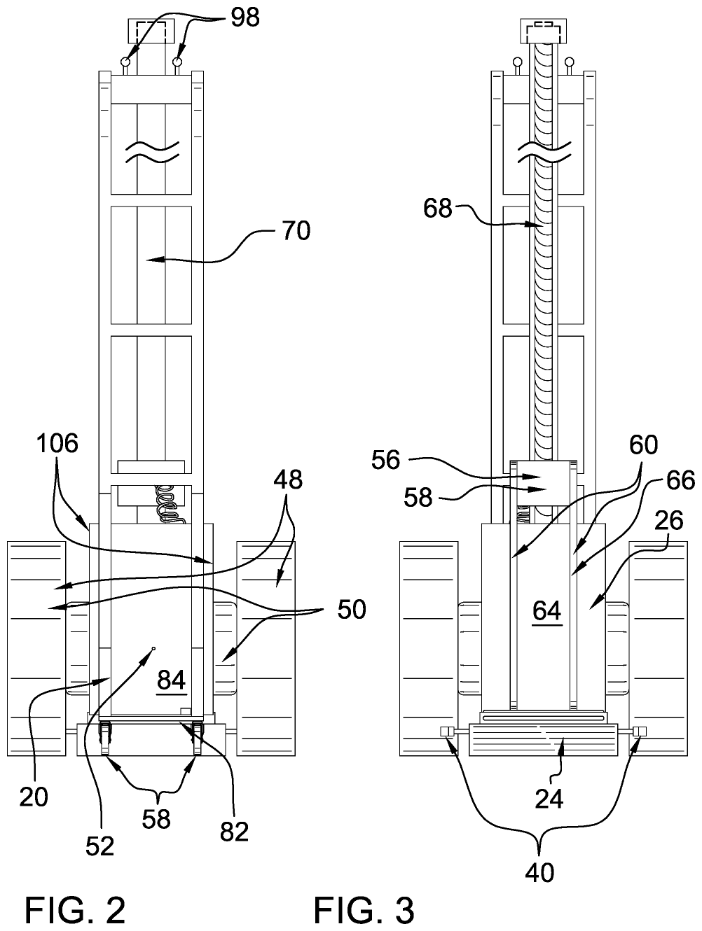

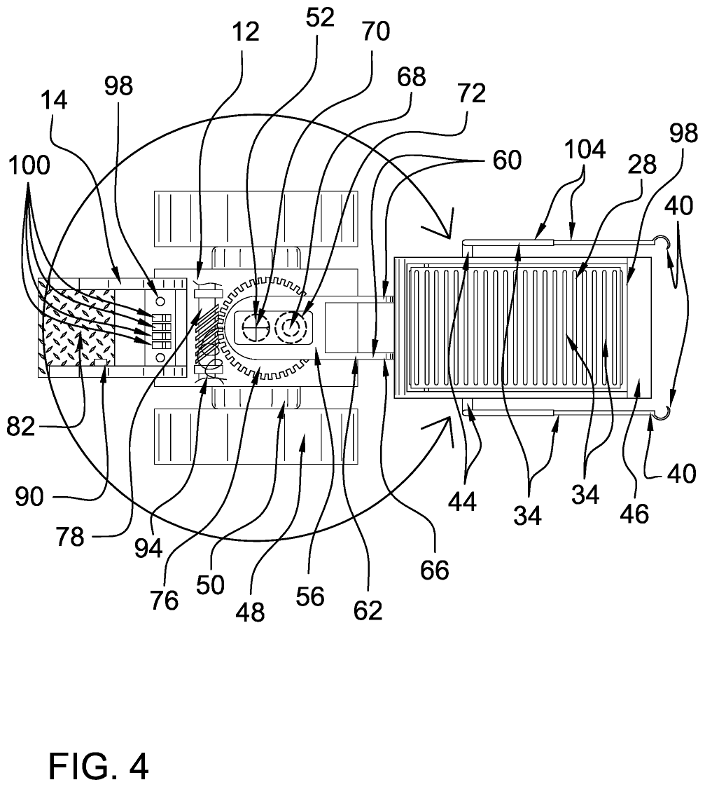

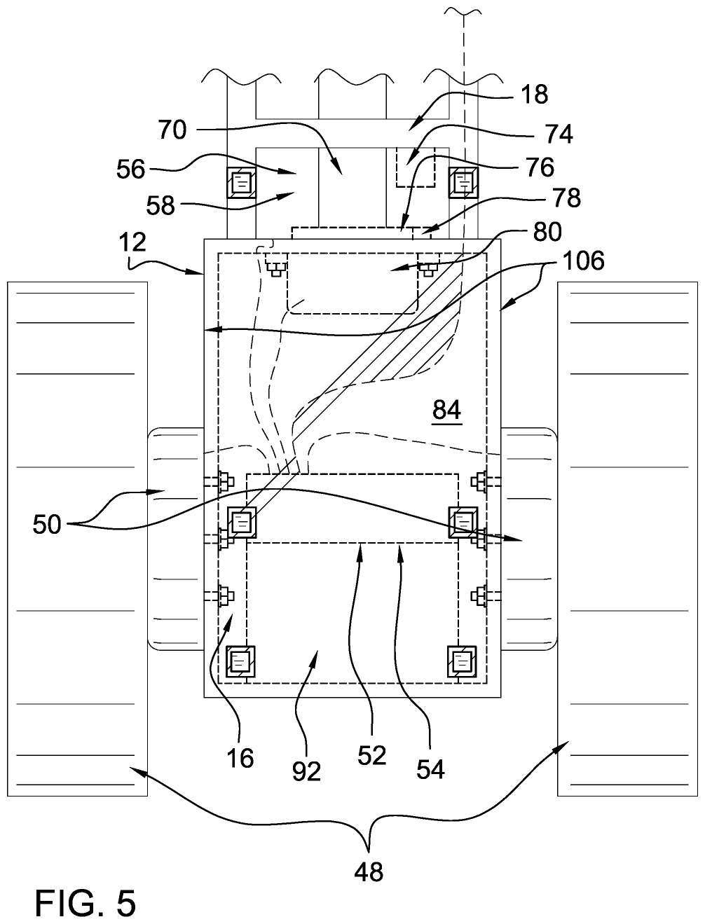

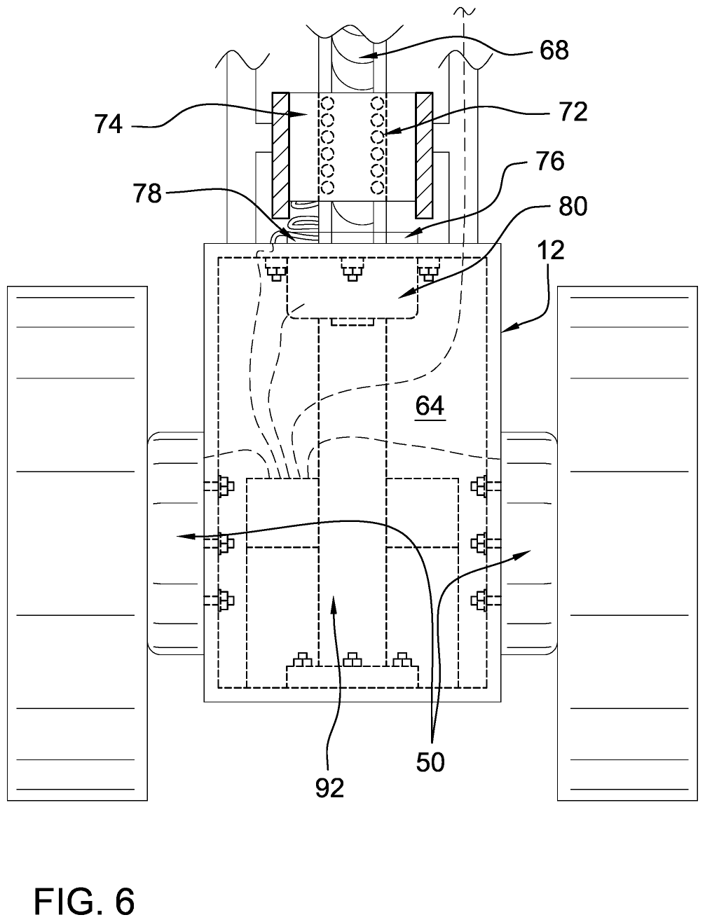

With reference now to the drawings, and in particular to FIGS. 1 through 10 thereof, a new hand truck assembly embodying the principles and concepts of an embodiment of the disclosure and generally designated by the reference numeral 10 will be described.

As best illustrated in FIGS. 1 through 10, the powered hand truck assembly 10 generally comprises a first housing 12, which is engaged to a frame 14 and which defines an interior space 16. A handle 18 is engaged to the frame 14 and extends upwardly from proximate to a rear 20 of the frame 14. A lift module 22 is engaged to and is selectively extensible from the first housing 12. A tray 24 is operationally engaged to the lift module 22 and extends from a front 26 of the frame 14. The tray 24 is configured for positioning of a load, while the lift module 22 is configured to selectively elevate the tray 24 and the load.

The tray 24 comprises an endless belt 28, which is positioned around a pair of pulleys 30, and a pair of belt motors 32. Each belt motor 32 is reversible and is operationally engaged to a respective pulley 30 so that the endless belt 28 is selectively rotatable by the belt motors 32. The endless belt 28 is configured to transfer the load from a surface to the tray 24 and from the tray 24 to a target location.

A plurality of ridges 34 is engaged to and extends from the endless belt 28. The ridges 34 are configured to frictionally engage the load to facilitate transfer of the load from the surface to the tray 24 and from the tray 24 to the target location.

The powered hand truck assembly 10 also may comprise a pair of arms 36, each of which is pivotally engaged to a respective opposed side 102 of the tray 24. The arm 36 comprises a plurality of nested sections 104 so that a terminus 42 of the arm 36 is selectively extensible past a load that is positioned proximate to a forward edge 38 of the tray 24. Each of a pair of hooks 40 is engaged to the terminus 42 of a respective arm 36. Each of a pair of actuators 44 is operationally engaged to a respective arm 36 so that the respective arm 36 is selectively actuatable by the actuator 36 to extend the respective arm 36 to position an associated hook 40 past the load, pivotable so that the respective arm 36 abuts an associated side of the load, and retractable such that the associated hook 40 engages the load. The pair of arms 36 thus is configured to pull the load onto the tray 24. The present invention also anticipates the pair of arms 36 being used to facilitate off-loading of the load from the tray 24.

The powered hand truck assembly 10 also may comprise a ramp 46, which is engaged to and extends transversely from the forward edge 38 of the tray 24 toward the surface. The ramp 46 is configured to facilitate transfer of the load to and from the tray 24.

A pair of drive wheels 48, which are positioned singly on opposed facets 104 of the first housing 12, is rotationally engaged to the first housing 12. A pair of drive motors 50 is engaged to the first housing 12 and positioned in the interior space 16. Each drive motor 50 is operationally engaged to a respective drive wheel 48. The drive motors 50 and the drive wheels 48 are configured to motivate the powered hand truck assembly 10 and the load across a surface and to effect 360° turns about a midpoint 52 of an axis of rotation 54 of the drive wheels 48.

The lift module 22 may comprise a second housing 56, which defines an internal space 58 and is positioned above the first housing 12. A pair of L-brackets 60 is engaged to and extends from the second housing 56. The L-brackets 60 are tubular. A first section 62 of each L-bracket 60 extends past a forward facet 64 of the first housing 12. A second section 66 of each L-bracket 60 extends toward the surface. The tray 24 is engaged to and extends from the second sections 66 distal from the first sections 62.

A ball screw 68 and a mast 70 are engaged to and extends vertically from the first housing 12 and through the second housing 56. A ball nut 72 is rotationally engaged to the second housing 56, is positioned in the internal space 58, and is operationally engaged to the ball screw 68. A ball motor 74 is engaged to second housing 56, is positioned in the internal space 58, and is operationally engaged to the ball nut 72. The ball motor 74 is reversible so that rotation of the ball nut 72 upon selective actuation of the ball motor 74 raises and lowers the tray 24 and the load.

The present invention also anticipates the lift module 22 comprising other lifting means, such as, but not limited to, hydraulic cylinders, racks and pinions, and the like.

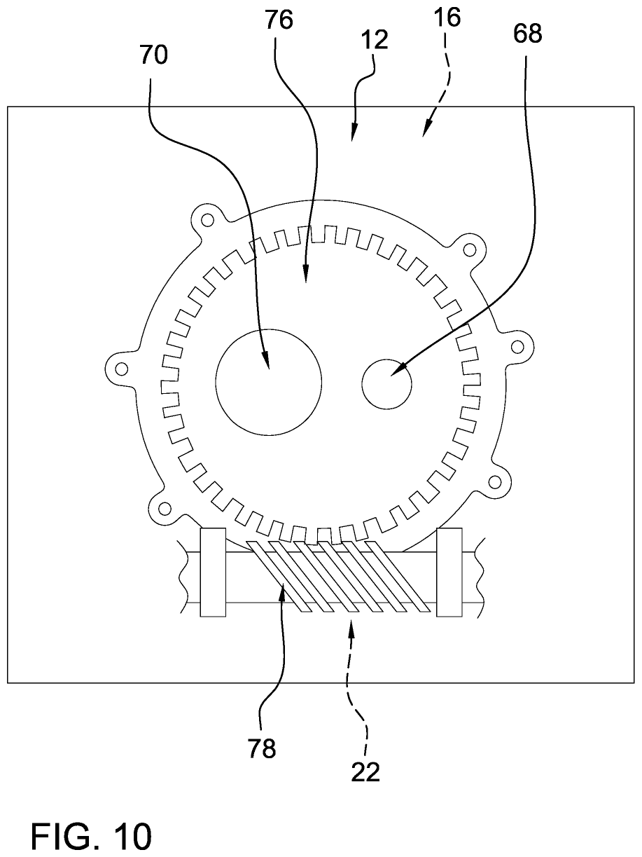

The powered hand truck assembly 10 also may comprise a cogwheel 76, which is rotationally engaged to the first housing 12. The ball screw 68 and the mast 70 are engaged to and extend vertically from the cogwheel 76. A worm gear 78 is engaged to the first housing 12 and is gearedly engaged to the cogwheel 76, as shown in FIG. 10. A worm motor 80 is engaged to the first housing 12 and is positioned in the interior space 16. The worm motor 80 is operationally engaged to the worm gear 78 so that the lift module 22, the tray 24, and the load are selectively rotatable. The user can selectively rotate the load when it is elevated, thereby facilitating repositioning of the load is a tight space. The present invention anticipates the load be rotatable 360° when elevated above the handle 18, and rotatable approximately 90° in either direction when not above the handle 18.

A platform 82 is engaged to the frame 14 and extends substantially perpendicularly to a rear facet 84 of the first housing 12. The platform 82 is configured to be stepped upon by a user so that a mass of the user counterbalances the load upon the tray 24. A pair of castors 86 is engaged to the platform 82 distal from the frame 14.

The powered hand truck assembly 10 also may comprise a sensor 88, which is engaged to the pair of arms 36 and is configured to detect contact of the load with the pair of arms 36. A pedal switch 90 is engaged to the platform 82 and is operationally engaged to the sensor 88. The pedal switch 90 is configured to be depressed to actuate the sensor 88.

A battery 92 is engaged to the first housing 12 and is positioned in the interior space 16. The battery 92 is operationally engaged to the pair of belt motors 32, the pair of actuators 44, the sensor 88, the pair of drive motors 50, the ball motor 74, and the worm motor 80. The present invention anticipates the battery 92 being one or both of rechargeable and removable.

Coiled wiring 94 extends between the first housing 12 and the second housing 56 to wiredly engage the battery 92 to the pair of belt motors 32, the pair of actuators 44, and the ball motor 74. The coiled wiring 94 is configured to uncoil as the tray 24 is elevated by the lift module 22.

A controller 96 is engaged to the handle 18 and is operationally engaged to the battery 92, the pair of belt motors 32, the pair of actuators 44, the sensor 88, the pair of drive motors 50, the ball motor 74, and the worm motor 80. The controller 96 may comprise a pair of joysticks 98 and a plurality of switches 100. Each joystick 98 is communicatively engaged with a respective drive motor 50. Each switch 100 is communicatively engaged to a respective one of the pair of belt motors 32, the pair of actuators 44, the sensor 88, the ball motor 74, and the worm motor 80.

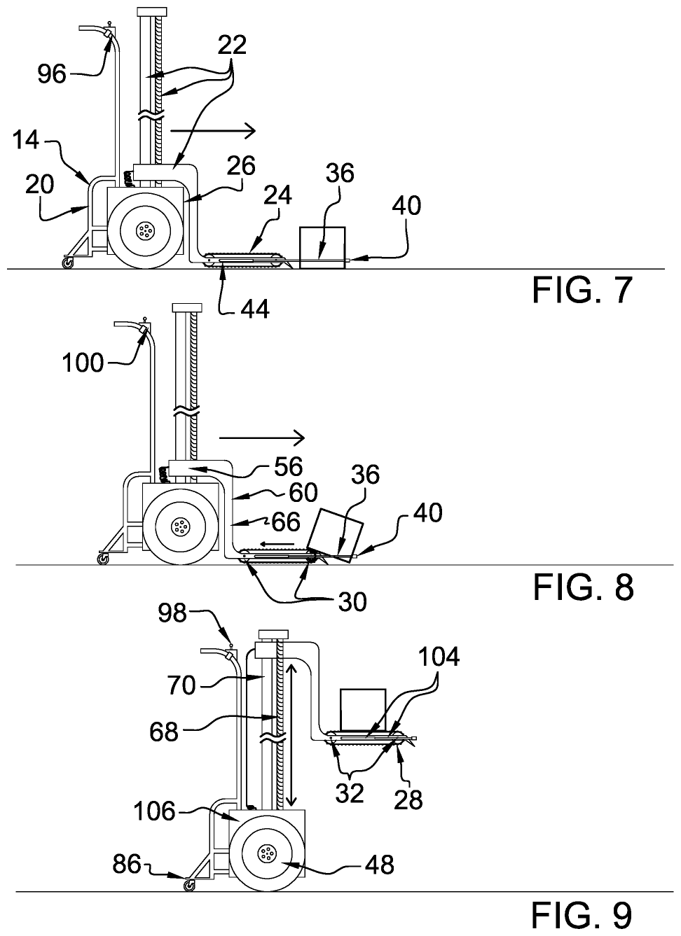

In use, a user stands upon the platform 82 and uses the joysticks 98 to selectively actuate the drive motors 50 to position the ramp 46 adjacent to a load, as shown in FIG. 7. A respective switch 100 is actuated to extend the arms 36 so that the hooks 40 can engage the load. Another respective switch 100 is actuated to retract the arms 36 and rotate the endless belt 28 so that the load is loaded upon the tray 24, as shown in FIG. 8. The user then can transport the load to a new location and/or can actuate yet another respective switch 100 to elevate the load (as shown in FIG. 9) to a height of the new location, for example, a shelf. If required due to operation in a tight space, the tray 24 and the load can be rotated by actuating the worm motor 80 or the powered hand truck assembly 10 and the load can be rotated by actuating the drive motors 50. The load can be deposited in the new location by reversing the endless belt 28.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A powered hand truck assembly comprising:
a frame;
a first housing engaged to the frame and defining an interior space;
a handle engaged to the frame and extending upwardly from proximate to a rear of the frame;
a lift module engaged to and selectively extensible from the first housing;
a tray operationally engaged to the lift module and extending from a front of the frame, wherein the tray is configured for positioning of a load and the lift module is configured for selectively elevating the tray and the load;
a pair of drive wheels rotationally engaged to the first housing and positioned singly on opposed facets of the first housing; and
a pair of drive motors engaged to the first housing and positioned in the interior space, each drive motor being operationally engaged to a respective drive wheel, wherein the drive motors and the drive wheels are configured for motivating the powered hand truck assembly and the load across a surface and for effecting 360° turns about a midpoint of an axis of rotation of the drive wheels.

2. The powered hand truck assembly of claim 1, further including:
the tray comprising an endless belt positioned around a pair of pulleys; and
a pair of belt motors, the belt motors being reversible, each belt motor being operationally engaged to a respective pulley, such that the endless belt is selectively rotatable by the belt motors, wherein the endless belt is configured for transferring the load from a surface to the tray and from the tray to a target location.

3. The powered hand truck assembly of claim 2, further including a plurality of ridges engaged to and extending from the endless belt, wherein the ridges are configured for frictionally engaging the load for facilitating transfer of the load from the surface to the tray and from the tray to the target location.

4. The powered hand truck assembly of claim 1, further including:
a pair of arms, each arm being pivotally engaged to a respective opposed side of the tray, the arm comprising a plurality of nested sections, such that a terminus of the arm is selectively extensible past a load positioned proximate to a forward edge of the tray;
a pair of hooks, each hook being engaged to the terminus of a respective arm; and
a pair of actuators, each actuator being operationally engaged to a respective arm, such that the respective arm is selectively actuatable by the actuator for extending the respective arm for positioning an associated hook past the load, pivotable so that the respective arm abuts an associated side of the load, and retractable such that the associated hook engages the load, wherein the pair of arms is configured for pulling the load onto the tray.

5. The powered hand truck assembly of claim 1, further including a ramp engaged to and extending transversely from the forward edge of the tray toward the surface, wherein the ramp is configured for facilitating transfer of the load to and from the tray.

6. The powered hand truck assembly of claim 1, wherein the lift module comprises:
a second housing defining an internal space, the second housing being positioned above the first housing;
a pair of L-brackets engaged to and extending from the second housing, the L-brackets being tubular, a first section of each L-bracket extending past a forward facet of the first housing, a second section of each L-bracket extending toward the surface, the tray being engaged to and extending from the second sections distal from the first sections;
a ball screw and a mast engaged to and extending vertically from the first housing and through the second housing;
a ball nut rotationally engaged to the second housing, positioned in the internal space, and operationally engaged to the ball screw; and
a ball motor engaged to the second housing, positioned in the internal space, and operationally engaged to the ball nut, the ball motor being reversible, such that rotation of the ball nut upon selective actuation of the ball motor raises and lowers the tray and the load.

7. The powered hand truck assembly of claim 6, further including:
a cogwheel rotationally engaged to the first housing;
the ball screw and the mast being engaged to and extending vertically from the cogwheel;
a worm gear engaged to the first housing and being gearedly engaged to the cogwheel; and
a worm motor engaged to the first housing and positioned in the interior space, the worm motor being operationally engaged to the worm gear, such that the lift module, the tray, and the load are selectively rotatable.

8. The powered hand truck assembly of claim 4, further including:
a platform engaged to the frame and extending substantially perpendicularly to a rear facet of the first housing, wherein the platform is configured for stepping upon by a user, such that a mass of the user counterbalances the load upon the tray; and
a pair of castors engaged to the platform distal from the frame.

9. The powered hand truck assembly of claim 8, further including:
a sensor engaged to the pair of arms and being configured for detecting contact of the load with the pair of arms; and
a pedal switch engaged to the platform and operationally engaged to the sensor, wherein the pedal switch is configured for depressing for actuating the sensor.

10. The powered hand truck assembly of claim 2, further including:
a pair of arms, each arm being pivotally engaged to a respective opposed side of the tray, the arm comprising a plurality of nested sections, such that a terminus of the arm is selectively extensible past a load positioned proximate to a forward edge of the tray;
a pair of hooks, each hook being engaged to the terminus of a respective arm;
a pair of actuators, each actuator being operationally engaged to a respective arm, such that the respective arm is selectively actuatable by the actuator for extending the respective arm for positioning an associated hook past the load, pivotable so that the respective arm abuts an associated side of the load, and retractable such that the associated hook engages the load, wherein the pair of arms is configured for pulling the load onto the tray;
the lift module comprising:
a second housing defining an internal space, the second housing being positioned above the first housing,
a pair of L-brackets engaged to and extending from the second housing, the L-brackets being tubular, a first section of each L-bracket extending past a forward facet of the first housing, a second section of each L-bracket extending toward the surface, the tray being engaged to and extending from the second sections distal from the first sections,
a ball screw and a mast engaged to and extending vertically from the first housing and through the second housing,
a ball nut rotationally engaged to the second housing, positioned in the internal space, and operationally engaged to the ball screw, and
a ball motor engaged to the second housing, positioned in the internal space, and operationally engaged to the ball nut, the ball motor being reversible, such that rotation of the ball nut upon selective actuation of the ball motor raises and lowers the tray and the load;
a cogwheel rotationally engaged to the first housing, the ball screw and the mast being engaged to and extending vertically from the cogwheel;
a worm gear engaged to the first housing and being gearedly engaged to the cogwheel;
a worm motor engaged to the first housing and positioned in the interior space, the worm motor being operationally engaged to the worm gear, such that the lift module, the tray, and the load are selectively rotatable;
a platform engaged to the frame and extending substantially perpendicularly to a rear facet of the first housing, wherein the platform is configured for stepping upon by a user, such that a mass of the user counterbalances the load upon the tray;
a pair of castors engaged to the platform distal from the frame.
a sensor engaged to the pair of arms and being configured for detecting contact of the load with the pair of arms;
a pedal switch engaged to the platform and operationally engaged to the sensor, wherein the pedal switch is configured for depressing for actuating the sensor; and
a battery engaged to the first housing and positioned in the interior space, the battery being operationally engaged to the pair of belt motors, the pair of actuators, the sensor, the pair of drive motors, the ball motor, and the worm motor.

11. The powered hand truck assembly of claim 10, further including coiled wiring extending between the first housing and the second housing for wiredly engaging the battery to the pair of belt motors, the pair of actuators, and the ball motor, wherein the coiled wiring is configured for uncoiling as the tray is elevated by the lift module.

12. The powered hand truck assembly of claim 10, further including a controller engaged to the handle and operationally engaged to the battery, the pair of belt motors, the pair of actuators, the sensor, the pair of drive motors, the ball motor, and the worm motor.

13. The powered hand truck assembly of claim 1, wherein the controller comprises:
a pair of joysticks, each joystick being communicatively engaged with a respective drive motor; and
and a plurality of switches, each switch being communicatively engaged to a respective one of the pair of belt motors, the pair of actuators, the sensor, the ball motor, and the worm motor.

14. A powered hand truck assembly comprising:
a frame;
a first housing engaged to the frame and defining an interior space;
a handle engaged to the frame and extending upwardly from proximate to a rear of the frame;
a lift module engaged to and selectively extensible from the first housing;
a tray operationally engaged to the lift module and extending from a front of the frame, wherein the tray is configured for positioning of a load and the lift module is configured for selectively elevating the tray and the load, the tray comprising an endless belt positioned around a pair of pulleys;
a pair of belt motors, the belt motors being reversible, each belt motor being operationally engaged to a respective pulley, such that the endless belt is selectively rotatable by the belt motors, wherein the endless belt is configured for transferring the load from a surface to the tray and from the tray to a target location;
a plurality of ridges engaged to and extending from the endless belt, wherein the ridges are configured for frictionally engaging the load for facilitating transfer of the load from the surface to the tray and from the tray to the target location;
a pair of arms, each arm being pivotally engaged to a respective opposed side of the tray, the arm comprising a plurality of nested sections, such that a terminus of the arm is selectively extensible past a load positioned proximate to a forward edge of the tray;
a pair of hooks, each hook being engaged to the terminus of a respective arm;
a pair of actuators, each actuator being operationally engaged to a respective arm, such that the respective arm is selectively actuatable by the actuator for extending the respective arm for positioning an associated hook past the load, pivotable so that the respective arm abuts an associated side of the load, and retractable such that the associated hook engages the load, wherein the pair of arms is configured for pulling the load onto the tray;
a ramp engaged to and extending transversely from the forward edge of the tray toward the surface, wherein the ramp is configured for facilitating transfer of the load to and from the tray;
a pair of drive wheels rotationally engaged to the first housing and positioned singly on opposed facets of the first housing;
a pair of drive motors engaged to the first housing and positioned in the interior space, each drive motor being operationally engaged to a respective drive wheel, wherein the drive motors and the drive wheels are configured for motivating the powered hand truck assembly and the load across a surface and for effecting 360° turns about a midpoint of an axis of rotation of the drive wheels;
the lift module comprising:
a second housing defining an internal space, the second housing being positioned above the first housing,
a pair of L-brackets engaged to and extending from the second housing, the L-brackets being tubular, a first section of each L-bracket extending past a forward facet of the first housing, a second section of each L-bracket extending toward the surface, the tray being engaged to and extending from the second sections distal from the first sections,
a ball screw and a mast engaged to and extending vertically from the first housing and through the second housing,
a ball nut rotationally engaged to the second housing, positioned in the internal space, and operationally engaged to the ball screw, and
a ball motor engaged to the second housing, positioned in the internal space, and operationally engaged to the ball nut, the ball motor being reversible, such that rotation of the ball nut upon selective actuation of the ball motor raises and lowers the tray and the load;
a cogwheel rotationally engaged to the first housing, the ball screw and the mast being engaged to and extending vertically from the cogwheel;
a worm gear engaged to the first housing and being gearedly engaged to the cogwheel;
a worm motor engaged to the first housing and positioned in the interior space, the worm motor being operationally engaged to the worm gear, such that the lift module, the tray, and the load are selectively rotatable;
a platform engaged to the frame and extending substantially perpendicularly to a rear facet of the first housing, wherein the platform is configured for stepping upon by a user, such that a mass of the user counterbalances the load upon the tray;
a pair of castors engaged to the platform distal from the frame;
a sensor engaged to the pair of arms and being configured for detecting contact of the load with the pair of arms;
a pedal switch engaged to the platform and operationally engaged to the sensor, wherein the pedal switch is configured for depressing for actuating the sensor;
a battery engaged to the first housing and positioned in the interior space, the battery being operationally engaged to the pair of belt motors, the pair of actuators, the sensor, the pair of drive motors, the ball motor, and the worm motor;
coiled wiring extending between the first housing and the second housing for wiredly engaging the battery to the pair of belt motors, the pair of actuators, and the ball motor, wherein the coiled wiring is configured for uncoiling as the tray is elevated by the lift module; and
a controller engaged to the handle and operationally engaged to the battery, the pair of belt motors, the pair of actuators, the sensor, the pair of drive motors, the ball motor, and the worm motor, the controller comprising:
a pair of joysticks, each joystick being communicatively engaged with a respective drive motor, and
and a plurality of switches, each switch being communicatively engaged to a respective one of the pair of belt motors, the pair of actuators, the sensor, the ball motor, and the worm motor.
